(19) United States
(12) Patent Application Publication
(10) Pub. No.: US 2018/0091798 A1
(43) Pub. Date: Mar. 29, 2018

(54) System and Method for Generating a Depth Map Using Differential Patterns

(71) Applicant: IMEC Taiwan Co., Hsinchu City (TW)

(72) Inventors: Ting-Ting Chang, Tainan City (TW); Chao-Kang Liao, New Taipei City (TW)

(73) Assignee: IMEC Taiwan Co., Hsinchu City (TW)

(21) Appl. No.: 15/275,685

(22) Filed: Sep. 26, 2016

(51) Int. Cl. H04N 13/02

(52) U.S. Cl. CPC H04N 13/0271; H04N 13/0253

(57) ABSTRACT

The present disclosure relates to an imaging system and a method of generating a depth map. The method comprises generating a first candidate depth map in response to a first pair of images associated with a first textured pattern, generating a second candidate depth map in response to a second pair of images associated with a second textured pattern different from the first textured pattern, determining one of pixels in a same location of the first and second candidate depth maps that is more reliable than the other; and generating a depth map based on the one pixel.

### BACKGROUND

Disparity estimation or depth extraction has been a topic of interest for years. Disparity or depth represents a distance between an object and a measuring device. Stereo matching is used to estimate disparity distances between corresponding pixels in a pair of stereo images or videos captured from parallel cameras in order to extract depth information of objects in a scene. Stereo matching has many applications such as three-dimensional (3D) gesture recognition, robotic imaging, vehicle industry, viewpoint synthesis, and stereoscopic TV. While stereo matching has advantageous features and has been widely used, there are still some limitations. For example, if an object is textureless, it may be difficult to obtain a dense and high-quality depth map. Stereo matching finds the correspondence point between more than two images and calculates 3D depth information. When the texture is low or repeated in a scene, the stereo matching has difficulty acquiring an accurate depth. As a result, textureless surfaces cannot be matched well by stereo.

### SUMMARY

The present disclosure is directed to an imaging system and method for generating a depth map by means of differential structured light and confidence level maps.

Embodiments according to the present disclosure provide an imaging system that includes a candidate depth map generating module, a confidence level determining module and a depth map forming module. The candidate depth map generating module is configured to generate a first candidate depth map in response to a first pair of images associated with a first textured pattern, and generate a second candidate depth map in response to a second pair of images associated with a second textured pattern different from the first textured pattern. The confidence level determining module is configured to determine one of pixels in a same location of the first and second candidate depth maps that is more reliable than the other. The depth map forming module is configured to generate a depth map based on the one pixel.

In an embodiment, the confidence level determining module includes a confidence level calculating module configured to generate a first confidence level map including information on reliability of pixels in the first candidate depth map, and generate a second confidence level map including information on reliability of pixels in the second candidate depth map.

In another embodiment, the confidence level determining module includes a confidence level comparing module configured to compare the first confidence level map against the second confidence level map to identify the more reliable pixel.

In yet another embodiment, the first textured pattern has a translational displacement with respect to the second textured pattern.

In still another embodiment, the first textured pattern has an angular displacement with respect to the second textured pattern.

In yet still another embodiment, the first textured pattern involves a different pattern from the second textured pattern.

Some embodiments according to the present disclosure provide a method of generating a depth map. According to the method, first structured light is projected onto an object. Moreover, a first candidate depth map associated with the first structured light is generated, and a first confidence level map including information on confidence level value of a first pixel in a first location of the first candidate depth map is generated. In addition, second structured light is projected onto the object, in which the second structured light produces a different textured pattern from the first textured light. Moreover, a second candidate depth map associated with the second structured light is generated, and a second confidence level map including information on confidence level value of a second pixel in a second location of the second candidate depth map is generated, in which the second location in the second candidate depth map is the same as the first location in the first candidate depth map. Subsequently, one of the first pixel and the second pixel that has a larger confidence level value is determined to be a third pixel. Then, a depth map using the third pixel is generated.

Embodiments according to the present disclosure also provide a method of generating a depth map. According to the method, based on a first textured pattern, a first depth map of first pixels is generated and a first confidence level map including information on reliability of the first pixels is generated. Moreover, based on a second textured pattern, a second depth map of second pixels is generated and a second confidence level map including information on reliability of the second pixels is generated. Furthermore, based on a third textured pattern, a third depth map of third pixels is generated and a third confidence level map including information on reliability of the third pixels is generated. Subsequently, by comparing among the first, second and third confidence level maps, one of the first, second and third pixels in a same location of the first, second and third confidence level maps that is most reliable is identified, and a depth map using the one pixel is generated.

The foregoing has outlined rather broadly the features and technical aspects of the present disclosure in order that the detailed description that follows may be better understood. Additional features and aspects of the present disclosure will be described hereinafter, and form the subject of the claims. It should be appreciated by those skilled in the art that the conception and specific embodiment disclosed might be readily utilized as a basis for modifying or designing other structures or processes for carrying out the same purposes of the present disclosure. It should also be realized by those skilled in the art that such equivalent constructions do not depart from the scope of the present disclosure as set forth in the following claims.

### BRIEF DESCRIPTION OF THE FIGURES

The objectives and aspects of the present disclosure will become apparent upon reading the following description and upon reference to the accompanying drawings in which:

FIG. 1 is a block diagram of a system for generating a depth map in accordance with an embodiment of the present disclosure;

FIG. 2 is a schematic diagram of a camera and projector assembly shown in FIG. 1 in accordance with an embodiment of the present disclosure;

FIG. 3 is a schematic diagram illustrating a conceptual model of generating a depth map by using differential light patterns in accordance with an embodiment of the present disclosure;

FIG. 4A is a block diagram of an imaging system shown in FIG. 1 in accordance with an embodiment of the present disclosure;

FIG. 4B is a block diagram of an imaging system shown in FIG. 1 in accordance with another embodiment of the present disclosure;

FIG. 5A is a schematic diagram of an exemplary pattern of structured light;

FIGS. 5B and 5C are schematic diagrams of differential patterns with respect to the exemplary pattern illustrated in FIG. 5A in accordance with some embodiments of the present disclosure;

FIG. 6A is a schematic diagram of another exemplary pattern;

FIG. 6B is a schematic diagram of a differential pattern with respect to the exemplary pattern illustrated in FIG. 6A in accordance with some embodiments of the present disclosure;

FIG. 7 is a flow diagram illustrating a method of generating a depth map by using differential patterns in accordance with an embodiment of the present disclosure;

FIG. 8 is a flow diagram illustrating a method of generating a depth map by using differential patterns in accordance with another embodiment of the present disclosure;

FIG. 9 is a schematic diagram illustrating a conceptual model of generating a depth map by using differential patterns in accordance with another embodiment of the present disclosure; and

FIG. 10 is a flow diagram illustrating a method of generating a depth map by using differential patterns in accordance with still another embodiment of the present disclosure.

### DETAILED DESCRIPTION

The embodiments of the present disclosure are shown in the following description with the drawings, wherein similar or same components are indicated by similar reference numbers.

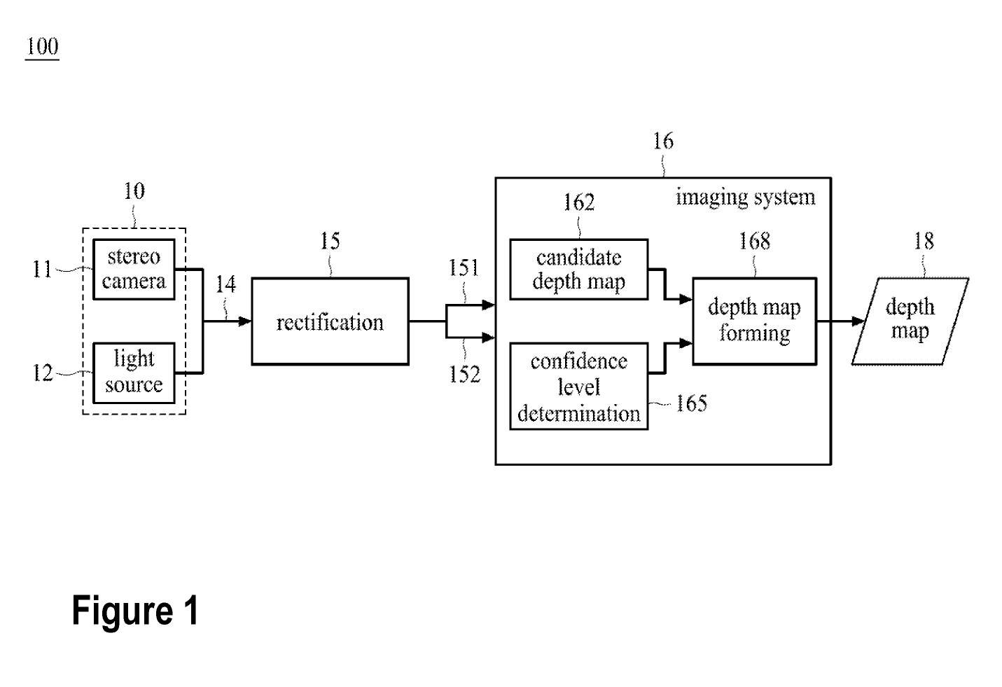

FIG. 1 is a block diagram of a system 100 for generating a depth map in accordance with an embodiment of the present disclosure. Referring to FIG. 1, the system 100 includes a camera and projector assembly 10, a calibration and rectification module 15 and an imaging system 16.

The camera and projector assembly 10 includes a stereo camera 11 and a projector 12. The stereo camera 11 captures a pair of raw images of an object in a scene from different viewpoints in a field of view. The object may be low texture or even textureless. The projector 12 illuminates structured light having a pattern towards the object. With the pattern, the structured light provides a textured pattern on the object and facilitates the system 100 to generate an accurate depth map. As a result, the camera and projector assembly 10 provides a pair of raw images 14 with a textured pattern to the calibration and rectification module 15.

The rectification module 15 calibrates the raw images 14 to remove lens distortion and rectifies the raw images 14 to remove co-planar and epi-polar mismatch so that a pair of output images, including a first image 151 and a second image 152, may be compared on single or multiple line-to-line basis.

The imaging system 16 includes a candidate depth map generating module 162, a confidence level determining module 165 and a depth map forming module 168. The candidate depth map generating module 162 generates a first candidate depth map in response to a first pair of images obtained using first structured light, and generates a second candidate depth map in response to a second pair of images obtained using second structured light. The first structured light and the second structured light exhibit differential textured patterns on the object 28 when projected onto the object 28. Each of the first and second candidate depth maps includes depth information, such as depth value, on each pixel. The confidence level determining module 165 determines the confidence level (or reliability) of the depth information. Moreover, the confidence level determining module 165 generates a first confidence level map including confidence level information, such as confidence level value, on each pixel in the first candidate depth map, and generates a second confidence level map including confidence level information on each pixel in the second candidate depth map. Pixels in a same location of the first and second candidate depth maps are compared with each other in confidence level. One of the pixels that has a larger confidence level value in the same location of the first and second candidate depth maps is identified. The depth map forming module 168 generates a depth map 18 by using the identified pixel as a pixel in a same location in the depth map 18.

The term “depth map” is commonly used in three-dimensional (3D) computer graphics applications to describe an image that contains information relating to the distance from a camera viewpoint to a surface of an object in a scene. The depth map 18 provides distance information of the object in the scene from the stereo camera 11. The depth map 18 is used to perform, for example, 3D gesture recognition, viewpoint synthesis, and stereoscopic TV presentation.

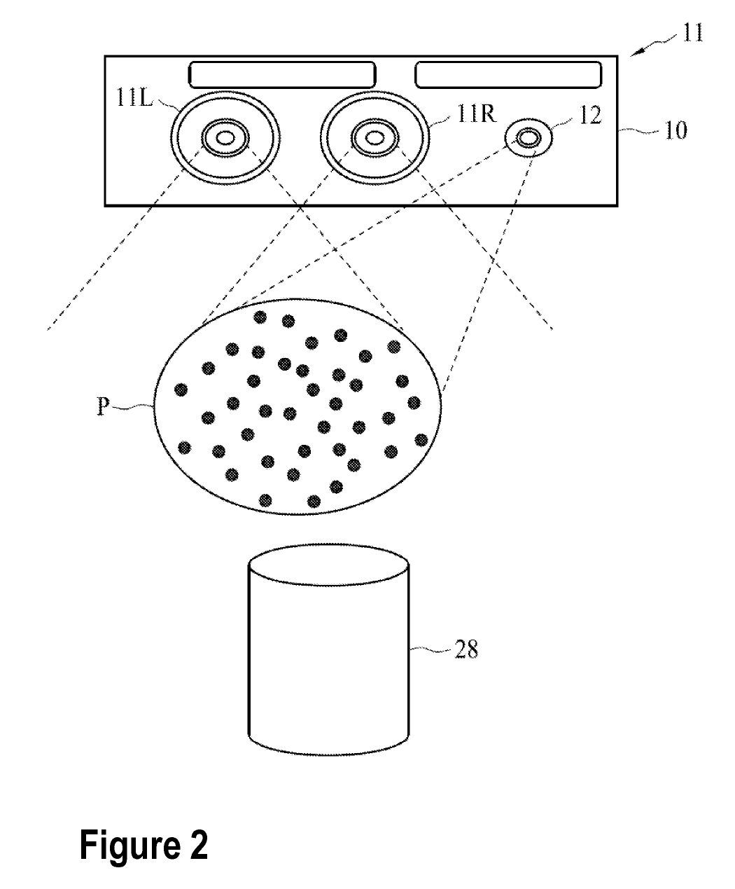

FIG. 2 is a schematic diagram of the camera and projector assembly 10 shown in FIG. 1 in accordance with an embodiment of the present disclosure. Referring to FIG. 2, the stereo camera 11 includes two sensors or cameras 11L and 11R aligned on an epi-polar line to capture a pair of raw images or videos of an object 28. Depending on different applications, the cameras 11L and 11R may be integrated in one apparatus or separately configured.

The projector 12 emits structured light onto the object 28 in a field of view of the projector 12. The emitted structured light has a pattern that may include stripes, spots, dots, triangles, grids or others. In the present embodiment, the cameras 11L and 11R are disposed on a common side of the projector 12. In another embodiment, the projector 12 is disposed between the cameras 11L and 11R. Furthermore, the cameras 11L, 11R and the projector 12 may be integrated in one apparatus as in the present embodiment or separately configured to suit different applications.

The projector 12 in an embodiment may include an infrared laser, for instance, having a wavelength of 700 nanometers (nm) to 3,000 nm, including near-infrared light, having a wavelength of 0.75 micrometers (mm) to 1.4 mm, mid-wavelength infrared light having a wavelength of 3 mm to 8 mm, and long-wavelength infrared light having a wavelength of 8 mm to 15 mm. In another embodiment, the projector 12 may include a light source that generates visible light. In still another embodiment, the projector 12 may include a light source that generates ultraviolet light. Moreover, light generated by the projector 12 is not limited to any specific wavelength, whenever the light can be detected by the cameras 11L and 11R. The projector 12 may also include a diffractive optical element (DOE) which receives the laser light and outputs multiple diffracted light beams. Generally, a DOE is used to provide multiple smaller light beams, such as thousands of smaller light beams, from a single collimated light beam. Each smaller light beam has a small fraction of the power of the single collimated light beam and the smaller, diffracted light beams may have a nominally equal intensity.

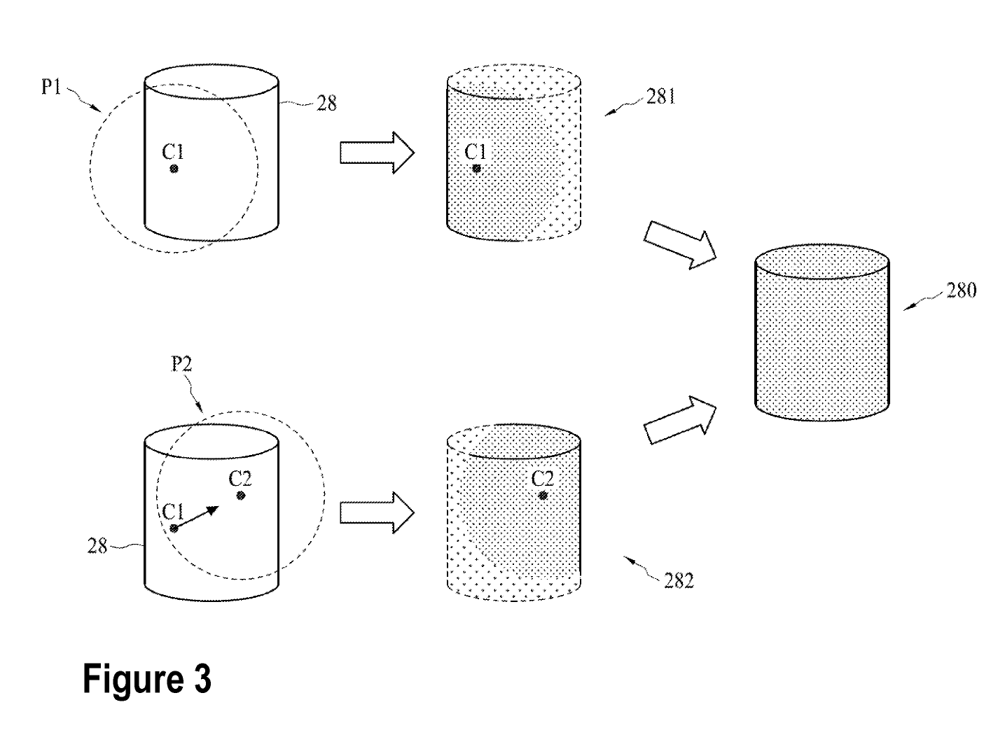

FIG. 3 is a schematic diagram illustrating a conceptual model of generating a depth map by using differential structured light patterns in accordance with an embodiment of the present disclosure. Referring to FIG. 3, also referring to FIG. 2, first structured light having a first pattern P1 (shown in a dashed-line circle) is emitted by the projector 12 towards a first position C1 onto the object 28. The first position C1 is, for example, the geographical center or centroid of the first pattern P1. An image of the object 28 with a first textured pattern produced by the first structured light is taken by the stereo camera 11. The imaging system 16 generates a first candidate depth map 281 and a first confidence level map. In the first candidate depth map 281, pixels in a region (show in solid lines) substantially around the first position C1 are more likely to have larger confidence level values than pixels in other regions (shown on dashed lines) and thus their depth values are more reliable.

Subsequently, second structured light having a second pattern P2 (shown in a dashed-line circle) is emitted by the projector 12 towards a second position C2 onto the object 28. Likewise, the second position C2 is the geographical center or centroid of the second pattern P2. An image of the object 28 with a second textured pattern produced by the second structured light is taken by the stereo camera 11. The first and second textured patterns are different from each other. The difference in textured patterns results from moving or changing the location of the second position C2 with respect to the first position C1, as shown by an arrow. The imaging system 16 generates a second candidate depth map 282 and a second confidence level map. Similarly, in the second candidate depth map 282, pixels in a region (show in solid lines) substantially around the second position C2 are more likely to have larger confidence level values than pixels in other regions (shown on dashed lines) and thus their depth values are more reliable.

By comparing the first and second confidence level maps across pixels in the first and second candidate depth maps 281 and 282, pixels that have a larger confidence level value than the others in same locations of the first and second candidate depth maps 281 and 282 are identified. These identified pixels, which are selected out of the first and second candidate depth maps 281 and 282 according to confidence level values, are filled in a depth map 280, thereby forming the depth map 280. Since each pixel in the depth map 280 represents a maximum confidence level value, the depth map 280 is more reliable and hence more accurate than the first and second candidate depth maps 281, 282.

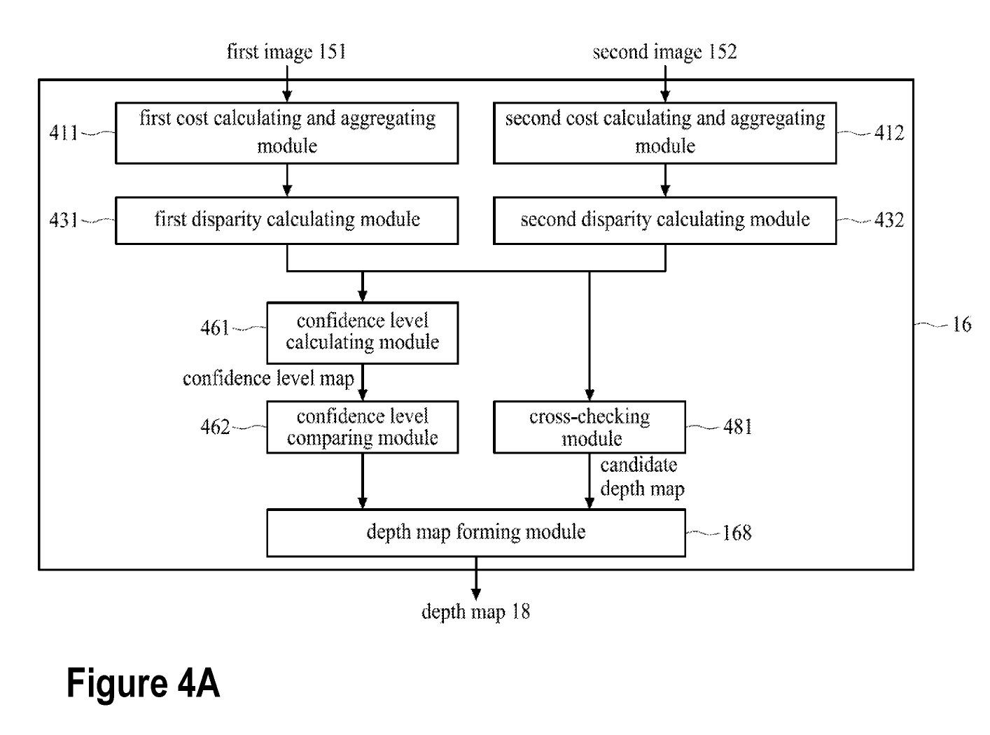

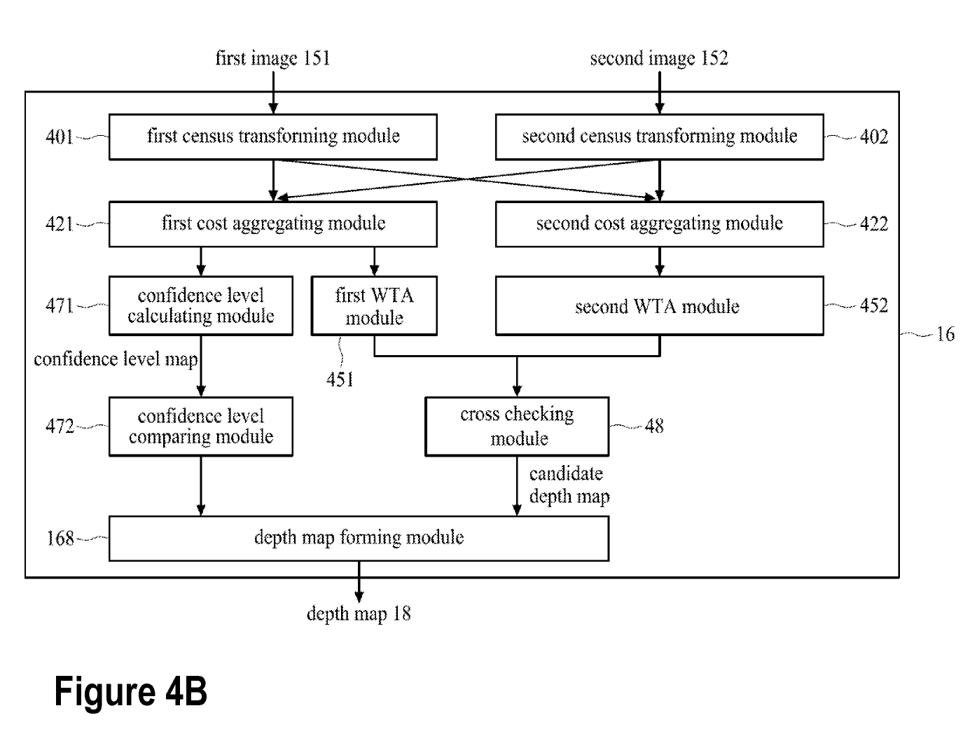

FIG. 4A is a block diagram of an imaging system 16 shown in FIG. 1 in accordance with an embodiment of the present disclosure. Referring to FIG. 4A, the imaging system 16 includes a first cost calculating and aggregating module 411, a second cost calculating and aggregating module 412, a first disparity calculating module 431, a second disparity calculating module 432, a confidence calculating module 461, a confidence level comparing module 462, a cross-checking module 481 and a depth map forming module 168.

The first cost calculating and aggregating module 411, including a first window buffer (not shown), is configured to obtain correlation lines of the first image 151, calculate current matching costs of the correlation line of the first image 151, and aggregate matching costs using the first window buffer. Similarly, the second cost calculating and aggregating module 412, including a second window buffer (not shown), is configured to obtain correlation lines of the second image 152, calculate current matching costs of the correlation line of the second image 152, and aggregate matching costs using the second window buffer. The first image 151 and the second image 152 of an object are taken while projecting a first textured pattern on the object.

The difference in image location of the object seen by the left and right cameras 11L and 11R is calculated in the first disparity calculating module 431 and the second disparity calculating module 432, resulting in a first disparity map and a second disparity map, respectively. Based on the first and second disparity maps, the confidence level calculating module 461 generates a first confidence level map associated with the first textured pattern. Subsequently, the confidence level calculating module 461 generates a second confidence level map associated with a second textured pattern. The first and second confidence level maps are compared against each other on a pixel to pixel basis by the confidence level comparing module 462 to determine the reliability of a pixel.

Moreover, the cross-checking module 481 is configured to cross check the first disparity map and the second disparity map to identify one or more mismatched disparity levels between the first and second disparity maps. As a result, a first candidate depth map associated with a first textured pattern is obtained. Subsequently, a second candidate depth map associated with a second textured pattern is obtained. The depth map forming module 168 generates a depth map based on the comparison result from the confidence level comparing module 462 and the candidate depth map from the cross-checking module 481.

FIG. 4B is a block diagram of the imaging system 16 shown in FIG. 1 in accordance with an embodiment of the present disclosure. Referring to FIG. 4B, the imaging system 16 includes, in addition to the depth map forming module 168, a first census transforming module 401, a first cost aggregating module 421, a first winner-take-all (WTA) module 451, a second census transforming module 402, a second cost aggregating module 422, a second WTA module 452, a confidence level calculating module 471, a confidence level comparing module 472 and a cross-checking module 482. Since disparity estimation and cross checking are known methods in stereo matching, their functions are briefly discussed below.

The first census transforming module 401 takes, for example, only 1 to 4 closest neighbor pixels into account, resulting in 1 to 4 binary digits representing the higher or lower image intensity as compared to the pixel under processing in the first image 151. Similarly, the second census transforming module 402 takes 1 to 4 closest neighbor pixels into account, resulting in 1 to 4 binary digits representing the higher or lower image intensity as compared to the pixel under processing in the second image 152. Next, the calculated binary digits from the first census transforming module 401 and the second census transforming module 402 are compared to each other with different disparity distances in order to determine a matching cost. The matching cost, which indicates the similarity of pixels between the first image 151 and the second image 152, can be aggregated by using a moving window with a reasonable size on each disparity level in the first cost aggregating module 421 and the second cost aggregating module 422. Then, the aggregated costs are sent to the first WTA module 451 and the second WTA module 452 to find a disparity with a minimum cost, which serves as a determined disparity for the pixel. Subsequently, by comparing the disparity results from the first WTA module 451 and the second WTA module 452, the cross checking module 48 calibrates most of the unreliable depth results by reference to the disparity of a surrounding region determined by an object edge in a disparity map.

The confidence level calculating module 471 and the confidence level comparing module 472 constitute the confidence level determining module 165 described and illustrated with reference to FIG. 1. After the cost aggregating stage, a costMap (x, y, d) is obtained, where x and y represent the location of current pixel, and d represents disparity. The costMap (x, y, d) records the matching cost between the first and second images 151, 152 at each pixel with different disparity. The confidence level calculating module 471 generates a confidence level map by calculating the cost value for each pixel after the cost aggregation stage. The minimum cost value (min_cost) represents the most matching disparity level at the current pixel. The average cost value AvgCost (x, y) here is calculated by the following formulas:

$$totalCost ( x , y ) = {\sum }_{d = 0}^{N} costMap ( x , y , d )$$

$$AvgCost ( x , y ) = \frac{totalCost ( x , y )}{N}$$

wherein “totalCost (x, y)” represents the summation of the cost value with each disparity level at the current pixel (x, y), and “N” represents the total number of disparity level. By subtracting min_cost from AvgCost at pixel (x, y), we can obtain the corresponding confidence level at the current pixel (x, y):

CL(x,y)=AvgCost(x,y)−min_cost(x,y)

Generally, for a desirable depth value, the min_cost should be near zero and the difference between AvgCost and min_cost should be as large as possible. As a result, the more reliable depth value, the larger the confidence level value.

The confidence level comparing module 472 compares a first confidence level map against a second confidence level map, and determines for each pixel location a pixel having a larger confidence level value in the first and second confidence level maps. Based on the pixels identified at the confidence level comparing module 472, the depth map forming module 168 generates the depth map 18.

In the present embodiment, the confidence level calculating module 471 is coupled to the first cost aggregating module 421 for determining a confidence level map. In another embodiment, the confidence level calculating module 471 is coupled to the second cost aggregating module 422 instead of the first cost aggregating module 421. In yet another embodiment, a first confidence level calculating module is coupled to the first cost aggregating module 421 while a second confidence level calculating module is coupled to the second cost aggregating module 422. Furthermore, to determine a confidence level map, the confidence level calculating module 471 is not limited to the specific formulas as described above. Moreover, the confidence level calculating module 471 may not be coupled to the first cost aggregating module 421 or the second cost aggregating module 422. As a result, other algorithms or mechanisms for determining a confidence level map in an imaging system using differential structured light patterns also fall within the contemplated scope of the present disclosure.

The imaging system 16 may be implemented in hardware such as in Field Programmable Gate Array (FPGA) and in Application-Specific Integrated Circuit (ASIC), or implemented in software using a general purpose computer system, or a combination thereof. Hardware implementation may achieve a higher performance compared to software implementation but at a higher design cost. For real-time applications, due to the speed requirement, hardware implementation is usually chosen.

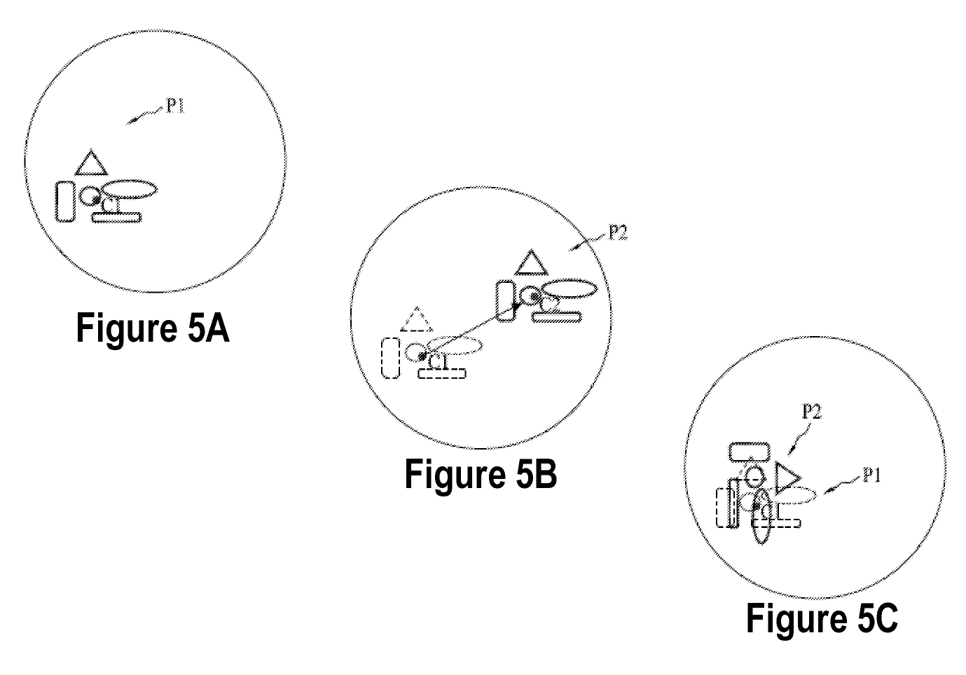

FIG. 5A is a schematic diagram of an exemplary pattern P1 of structured light. Referring to FIG. 5A, first structured light having a first pattern P1 is projected towards a first position C1.

FIGS. 5B and 5C are schematic diagrams of differential patterns P2 with respect to the exemplary pattern P1 illustrated in FIG. 5A in accordance with some embodiments of the present disclosure. Referring to FIG. 5B and also to FIG. 5A, second structured light having a second pattern P2 is projected towards a second position C2. The second structured light or the second pattern P2 is displaced from C1 to C2 with respect to the first structured light or the first pattern P1. In the present embodiment, the second pattern P2 is the same as the first pattern P1 but has a translational displacement from the first pattern P1. Effectively, by moving or changing the position of structured light, a different textured pattern is acquired.

Referring to FIG. 5C and also to FIG. 5A, the second structured light having a second pattern P2 is projected towards the first position C2. Moreover, the second pattern P2 is the same as the first pattern P1. However, the second pattern P2 has an angular displacement from the first pattern P1. Effectively, by rotating the position of structured light, a different textured pattern is acquired.

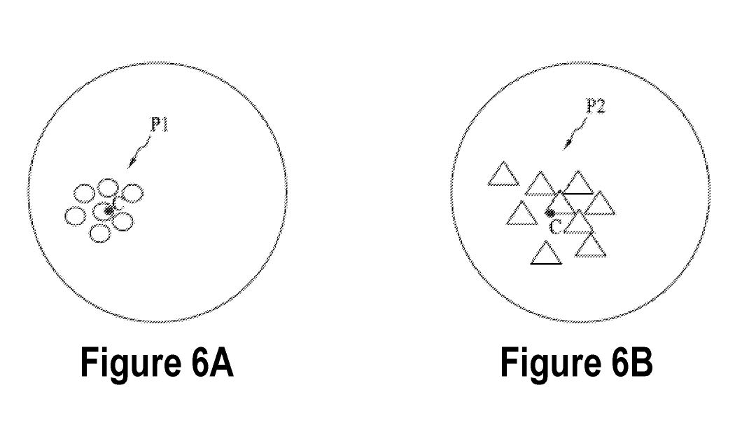

FIG. 6A is a schematic diagram of another exemplary pattern, and FIG. 6B is a schematic diagram of a differential pattern with respect to the exemplary pattern illustrated in FIG. 6A in accordance with some embodiments of the present disclosure. Referring to FIGS. 6A and 6B, first structured light and second structured light are projected towards a same position C. Moreover, the first pattern P1 and the second pattern P2 are different from each other. Effectively, by using a different pattern, even though the structured light having the different pattern is projected towards the same position as the previous structured light, a different textured pattern is acquired.

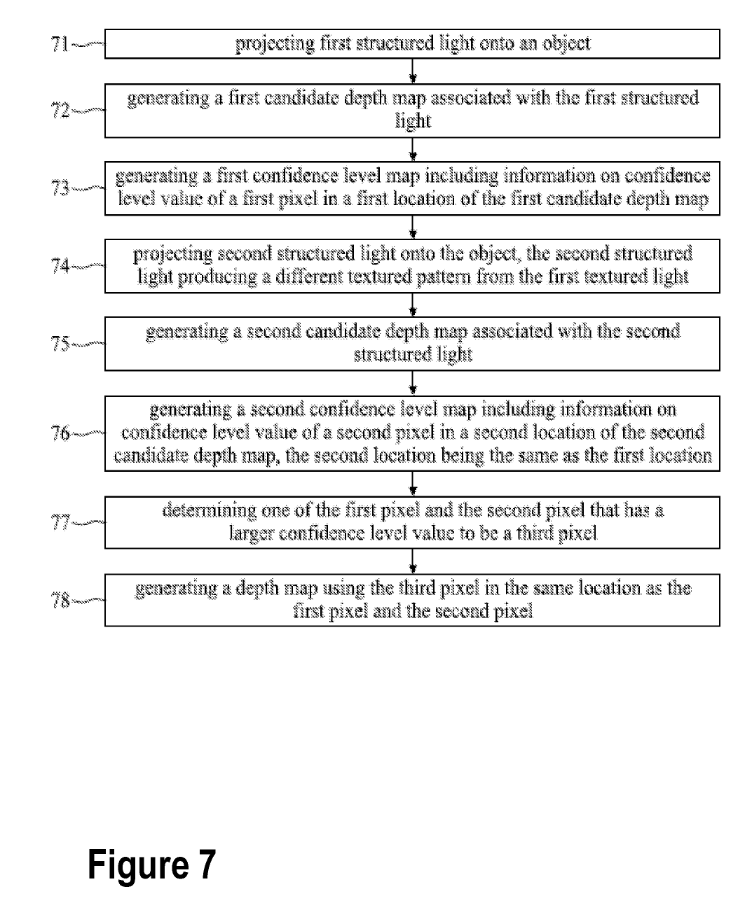

FIG. 7 is a flow diagram illustrating a method of generating a depth map by using differential patterns in accordance with an embodiment of the present disclosure. Referring to FIG. 7, and also by reference to the system 100 illustrated in FIG. 1, in operation 71, first structured light is projected onto an object. Next, in operation 72, a first candidate depth map associated with the first structured light is generated. Moreover, in operation 73, a first confidence level map including information on confidence level value of a first pixel in a first location of the first candidate depth map is generated.

Subsequently, in operation 74, second structured light is projected onto the object. The second structured light produces a different textured pattern from the first textured light. Next, in operation 75, a second candidate depth map associated with the second structured light is generated. Moreover, in operation 76, a second confidence level map including information on confidence level value of a second pixel in a second location of the second candidate depth map is generated. The second location in the second candidate depth map is the same as the first location in the first candidate depth map in pixel coordinates.

In operation 77, one of the first pixel and the second pixel that has a larger confidence level value is determined to be a third pixel. Then in operation 78, a depth map using the third pixel in the same location as the first pixel and the second pixel is generated. Accordingly, a final depth map can be generated by comparing the confidence level values of pixels in same locations in the first and second confidence level maps and filing pixels having larger confidence level values in their respective pixel coordinates in the depth map.

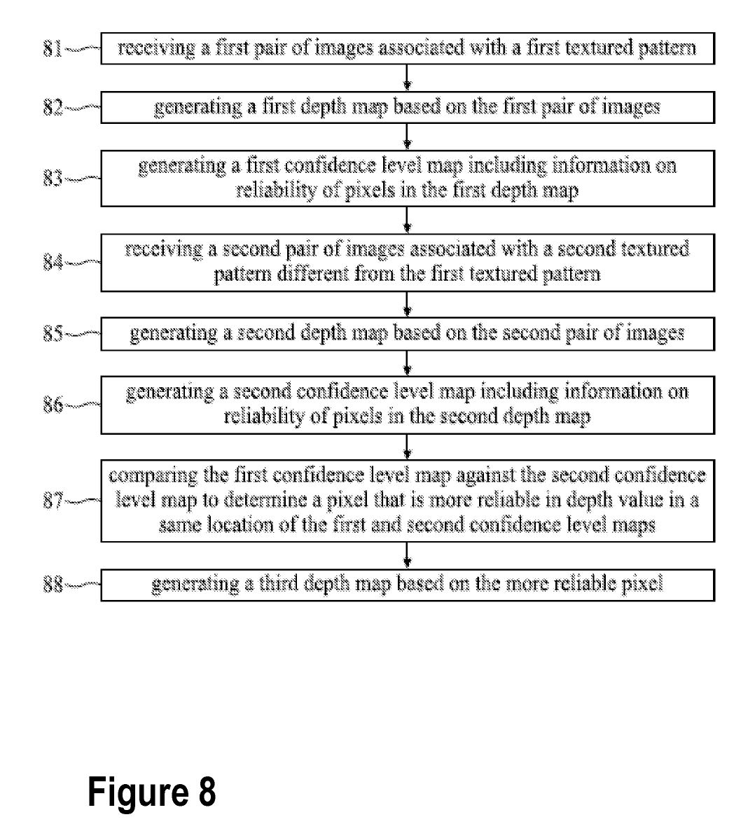

FIG. 8 is a flow diagram illustrating a method of generating a depth map by using differential patterns in accordance with another embodiment of the present disclosure. Referring to FIG. 8, and also by reference to the imaging system 16 illustrated in FIG. 1 or FIG. 4, in operation 81, a first pair of images associated with a first textured pattern is received. Next, in operation 82, a first depth map based on the first pair of images is generated. Furthermore, in operation 83, a first confidence level map including information on reliability of pixels in the first depth map is generated.

Subsequently, in operation 84, a second pair of images associated with a second textured pattern is received. The second textured pattern is different from the first textured pattern. Next, in operation 85, a second depth map based on the second pair of images is generated. Furthermore, in operation 86, a second confidence level map including information on reliability of pixels in the second depth map is generated.

In operation 87, the first confidence level map is compared against the second confidence level map to determine a pixel that is more reliable in depth value in a same location of the first and second confidence level maps. Then in operation 88, a third depth map is generated based on the more reliable pixel.

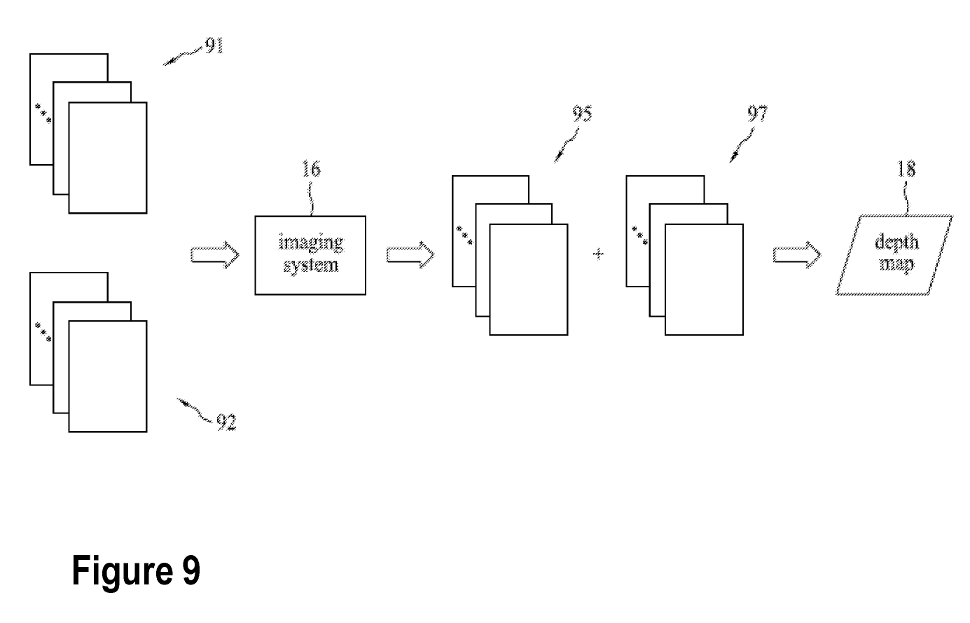

In the above-mentioned embodiments, two (candidate) depth maps and two confidence level maps are generated to determine a final depth map. In other embodiments, however, three or more (candidate) depth maps and the same number of confidence level maps may be used in order to generate a more accurate depth map. FIG. 9 is a schematic diagram illustrating a conceptual model of generating a depth map by using differential patterns in accordance with another embodiment of the present disclosure. Referring to FIG. 9, the imaging system 16 may be configured to receive M sets of first images 91 and second images 92 which are generated in pair using differential structured light, M being a natural number greater than two. For each set of the paired first and second images, the first image 91 is obtained by using first structured light and the second image 92 is obtained by using second structured light having different textured pattern from the first structured light. The imaging system 16 generates M (candidate) depth maps 95 and M confidence level maps 97 and then determines a final depth map.

For example, the imaging system 16 generates a first candidate depth map and a first confidence level map in response to a first pair of images obtained using the first structured light. Moreover, the imaging system 16 generates a second candidate depth map and a second confidence level map in response to a second pair of images obtained using the second structured light Then, the imaging system 16 generates a third candidate depth map and a third confidence level map in response to a third pair of images obtained using third structured light that produces a different textured pattern from the first and second structured light. Subsequently, the imaging system 16 compares among the first, second and third confidence level maps in order to determine a final depth map.

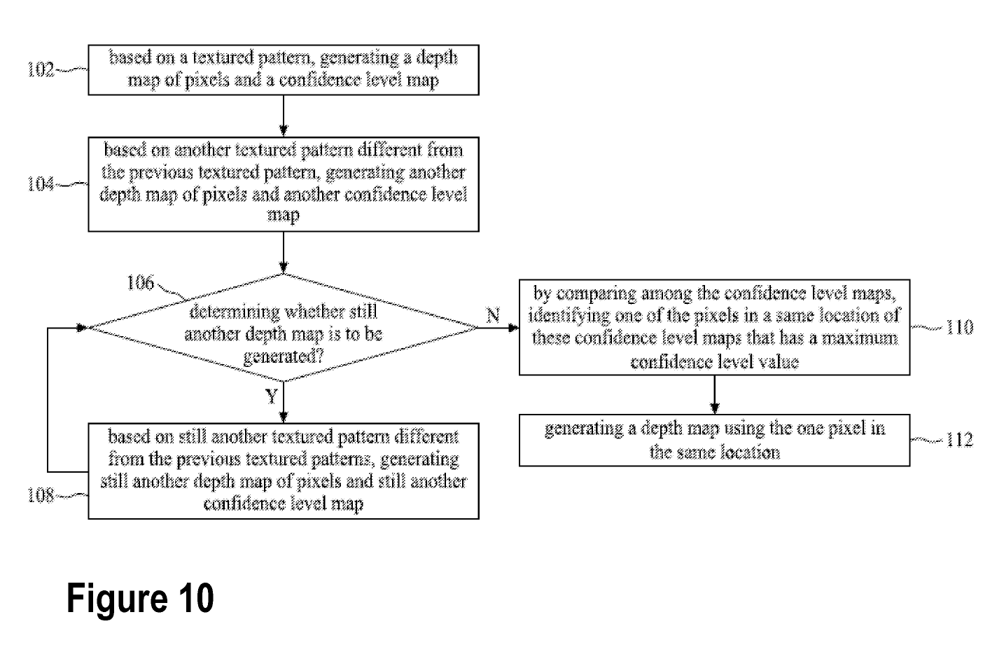

FIG. 10 is a flow diagram illustrating a method of generating a depth map by using differential patterns in accordance with still another embodiment of the present disclosure. Referring to FIG. 10 and also by reference to the conceptual model illustrated in FIG. 9, in operation 102, based on a textured pattern, a depth map of pixels and a confidence level map are generated. Further, in operation 104, based on another textured pattern different from the previous textured pattern, another depth map of pixels and another confidence level map are generated. Next, in operation 106, it is determined whether still another depth map is to be generated. For example, it may be predetermined that N sets of depth maps and confidence level maps are used to determine a final depth map. If affirmative, then in operation 108, based on still another textured pattern different from the previous textured patterns, still another depth map of pixels and still another confidence level map are generated. Operations 106 and 108 are repeated until the predetermined number of depth maps and confidence level maps are obtained. When obtained, in operation 110, by comparing among the confidence level maps, one of the pixels in a same location of these confidence level maps that has a maximum confidence level value is identified. Subsequently, in operation 112 a depth map is generated using the identified pixel in the same location.

In summary, the present disclosure provides an imaging system and method that improve the quality of a depth map by means of differential structured light and confidence level maps without increasing the system complexity. With the improved quality of the depth map and controlled complexity, the present disclosure is suitable for applications such as 3D gesture recognition, view point synthesis and stereoscopic TV.

Although the present disclosure and its aspects have been described in detail, it should be understood that various changes, substitutions and alterations can be made herein without departing from the scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. An imaging system, comprising:
a candidate depth map generating module configured to generate a first candidate depth map in response to a first pair of images associated with a first textured pattern, and generate a second candidate depth map in response to a second pair of images associated with a second textured pattern different from the first textured pattern;
a confidence level determining module configured to determine one of pixels in a same location of the first and second candidate depth maps that is more reliable than the others; and
a depth map forming module configured to generate a depth map based on the one pixel.

2. The imaging system according to claim 1, wherein the confidence level determining module comprises a confidence level calculating module configured to generate a first confidence level map including information on reliability of pixels in the first candidate depth map, and generate a second confidence level map including information on reliability of pixels in the second candidate depth map.

3. The imaging system according to claim 2, wherein the confidence level calculating module generates the first confidence level map or the second confidence level map based on the following formulas:
$$totalCost ( x , y ) = {\sum }_{d = 0}^{N} costMap ( x , y , d ) , and$$
$$AvgCost ( x , y ) = \frac{totalCost ( x , y )}{N}$$
wherein costMap (x, y, d) represents a matching cost between the first and second pairs of images, x and y represent the location of a pixel, d represents disparity, and N represents the total number of disparity level.

4. The imaging system according to claim 3, wherein the confidence level calculating module determines the confidence level of the pixel based on the following formula:
CL(x,y)=AvgCost(x,y)−min_cost(x,y)
wherein min_cost (x, y) represents the most matching disparity level at the pixel.

5. The imaging system according to claim 2, wherein the confidence level determining module includes a confidence level comparing module configured to compare the first confidence level map against the second confidence level map to identify the more reliable pixel.

6. The imaging system according to claim 1, wherein the first textured pattern has a translational displacement with respect to the second textured pattern.

7. The imaging system according to claim 1, wherein the first textured pattern has an angular displacement with respect to the second textured pattern.

8. The imaging system according to claim 1, wherein the first textured pattern involves a different pattern from the second textured pattern.

9. A method of generating a depth map, the method comprising:
projecting first structured light onto an object;
generating a first candidate depth map associated with the first structured light;
generating a first confidence level map including information on confidence level value of a first pixel in a first location of the first candidate depth map;
projecting second structured light onto the object, the second structured light producing a different textured pattern from the first textured light;
generating a second candidate depth map associated with the second structured light;
generating a second confidence level map including information on confidence level value of a second pixel in a second location of the second candidate depth map, the second location in the second candidate depth map being the same as the first location in the first candidate depth map;
determining one of the first pixel and the second pixel that has a larger confidence level value to be a third pixel; and
generating a depth map using the third pixel.

10. The method according to claim 9, wherein the first structured light has a translational displacement with respect to the second structured light.

11. The method according to claim 9, wherein the first structured light has an angular displacement with respect to the second structured light.

12. The method according to claim 9, wherein the first structured light includes a pattern different from the second structured light.

13. The method according to claim 9, wherein generating the first confidence level map or generating the second confidence level map comprises calculation based on the following formulas:
$$totalCost ( x , y ) = {\sum }_{d = 0}^{N} costMap ( x , y , d ) , and$$
$$AvgCost ( x , y ) = \frac{totalCost ( x , y )}{N}$$
wherein costMap (x, y, d) represents a matching cost between the first and second pairs of images, x and y represent the location of a pixel, d represents disparity, and N represents the total number of disparity level.

14. The method according to claim 13, wherein generating the first confidence level map or generating the second confidence level map further comprises calculation based on the following formula:
CL(x,y)=AvgCost(x,y)−min_cost(x,y)
wherein min_cost (x, y) represents the most matching disparity level at the pixel.

15. A method of generating a depth map, the method comprising:
based on a first textured pattern, generating a first depth map of first pixels and a first confidence level map including information on reliability of the first pixels;
based on a second textured pattern, generating a second depth map of second pixels and a second confidence level map including information on reliability of the second pixels;
based on a third textured pattern, generating a third depth map of third pixels and a third confidence level map including information on reliability of the third pixels;
comparing among the first, second and third confidence level maps to identify one of the first, second and third pixels in a same location of the first, second and third confidence level maps that is most reliable; and
generating a depth map using the one pixel.

16. The method according to claim 15, wherein the first, second and third textured patterns are different from each another.

17. The method according to claim 15 further comprising:
projecting first structured light having a first pattern onto an object to produce the first textured pattern; and
projecting second structured light having a second pattern onto the object to produce the second textured pattern.

18. The method according to claim 17, wherein the first pattern has a translational displacement with respect to the second pattern.

19. The method according to claim 17, wherein the first pattern has an angular displacement with respect to the second pattern.

20. The method according to claim 17, wherein the first pattern and the second pattern are different from each other.
